(19) United States
(12) Patent Application Publication
(10) Pub. No.: US 2018/0083316 A1
(43) Pub. Date: Mar. 22, 2018

(54) NON-AQUEOUS ELECTROLYTE FOR LITHIUM-ION BATTERY, AND LITHIUM-ION BATTERY

(71) Applicant: SHENZHEN CAPCHEM TECHNOLOGY CO., LTD, Shenzhen, Guangdong (CN)

(72) Inventors: Qiao SHI, Shenzhen (CN); Muchong LILN, Shenzhen (CN); Dixiong ZHOU, Shenzhen (CN); Hailing ZHANG, Shenzhen (CN)

(73) Assignee: SHENZHEN CAPCHEM TECHNOLOGY CO., LTD, Shenzhen, Guangdong (CN)

(21) Appl. No.: 15/559,014

(22) PCT Filed: Jul. 9, 2015
(86) PCT No.: PCT/CN2015/083624

§ 371 Date: Sep. 15, 2017

(51) Int. Cl. H01M 10/0567; H01M 10/0525; H01M 10/0568

(52) U.S. Cl. CPC H01M 10/0567; H01M 2300/0025; H01M 10/0568; H01M 10/0525

(57) ABSTRACT

A non-aqueous electrolyte for a lithium-ion battery, and the lithium-ion battery. The non-aqueous electrolyte comprises an organic solvent, a lithium salt, and an additive. The additive comprises 0.1 wt % to 2 wt % of 1,2,3-trifluorobenzene calculated according to the weight of the non-aqueous electrolyte. By adding 1,2,3-trifluorobenzene to the electrolyte as the additive, the compatibility of the electrolyte and an electrode sheet can be effectively improved and the permeability of the electrolyte on the electrode can be improved; and the 1,2,3-trifluorobenzene has the positive electrode film forming effect, and accordingly the positive electrode can be protected and the high-temperature energy storage performance and the cycle performance can be improved.

### TECHNICAL FIELD

The present invention relates to the technical field of electrochemistry, particularly relates to a non-aqueous electrolyte for a lithium-ion battery, and a lithium-ion battery.

### BACKGROUND OF THE INVENTION

Presently, lithium-ion batteries are the most popular and the most widely used secondary battery thanks to their excellent electrochemical properties as well as safety and environment-friendliness, among other performances. With the ongoing demand of new energy vehicles on mileage range and the continual progress in lightness and thinness of 3 C digital products, the battery industry more and more requires high energy densification of lithium-ion batteries. Presently, high energy densification is mainly achieved by two approaches, namely, adoption of high capacity cathodes and high capacity anodes. Currently, relatively developed high capacity cathodes mainly use high voltage lithium cobalt oxide material, examples thereof being the well-developed 4.35 V and the near-developed 4.4 V high voltage lithium cobalt oxide cathode; while high capacity anodes mainly include highly compacted graphite anode and silicon-carbon alloy material. The silicon-carbon alloy material suffers from relatively large volume increase during cycling, which would greatly deteriorate the cycling performance. This problem is still hard to address at present, thus high capacity silicon-carbon alloy anode material could not be readily commercialized in a short period, and the highly compacted graphite anode mainly represents the common high capacity anode. The highly compacted graphite anode generally has a compacted density of 1.6-1.75 g/cm³, and the compacting technique is relatively developed, leading to large-scale application of the highly compacted graphite anode in 3 C digital batteries. A compacted density of the anode of 1.8 g/cm³ or higher would be the next technological trend for high capacity graphite anodes.

Presently, the relatively developed high energy density lithium-ion batteries for 3 C digital products are mainly high-voltage lithium cobalt oxide batteries. Such a battery system generally has a compacted density of the cathode of 4.0 g/cm³ or higher and a compacted density of the anode of 1.65 g/cm³ or higher. Such a highly compacted battery system usually suffers from the problem of difficulty in electrolyte permeation. As the cathode and the anode have a high compacted density, the electrode plates are relatively thick, and the space between the particles of the electrode material is relatively small, it is very difficult for the electrolyte to permeate into the electrode plates in a short time. This may result in poor retention of the electrolyte during battery manufacturing, leading to the problems of severely insufficient battery cycling performance and of lithium precipitation. Moreover, the problem of difficulty in permeation of the electrolyte through the interface of the highly compacted cathode or anode results in increased contact internal resistance between the electrolyte and the electrode, which would affect the achievement of battery capacity and the high-rate charge-discharge performance.

In order to address the problem of difficulty in permeation of the electrolyte in a highly compacted battery system, the prior art technologies adopt the approach of adding a fluorobenzene compound in the electrolyte, examples thereof including:

(1) the invention patent having the patent number of CN103715454A and the patent title of “Electrolyte for lithium-ion battery and secondary battery comprising the electrolyte”, which discloses adding a fluorobenzene compound in the electrolyte in an amount of 1-15% based on the total weight of the electrolyte, the fluorobenzene compound used being selected from at least one of p-fluorotoluene, 2-fluorotoluene, 3-fluorotoluene, 1,3-difluorobenzene, trifluorotoluene, p-fluorophenol, p-chlorofluorobenzene, p-bromofluorobenzene, 2-bromo-4-fluorophenol, 2,4-dichlorofluorobenzene, p-fluorophenyl methyl sulfone, ethyl 5-fluorobenzoate, 1-acetoxy-2-fluorobenzene, 1-acetoxy-3-fluorobenzene, 1-acetoxy-4-fluorobenzene, 2-acetoxy-2,4-difluorobenzene and allyl pentafluorobenzene;

(2) the invention patent having the patent number of CN103531864A and the patent title of “Lithium-ion battery, and electrolyte therefor”, which discloses adding a fluorobenzene in the electrolyte in an amount of 1.0-5.0% based on the weight of the electrolyte;

(3) the invention patent having the patent number of CN104466248A and the patent title of “electrolyte, and lithium-ion battery utilizing the electrolyte”, which discloses adding a fluorobenzene in the electrolyte in an amount of 0.1-15% based on the weight of the electrolyte.

The fluorobenzene compounds added in the above-said patents enhance the permeation performance of the electrolyte, increase the battery capacity, and improve the charge-discharge cycling performance and the high-temperature and low-temperature storage performance of the battery to a certain extent, but with limited effect. Moreover, for graphite anode material having a compacted density of 1.65 g/cm³ or higher, the enhancement in the permeation performance of the electrolyte is not evident. Therefore, it is a difficult technical task for a person skilled in the art to seek an electrolyte additive capable of markedly enhancing the permeation performance of the electrolyte, in particular in a battery system having a compacted density of the anode of 1.65 g/cm³ or higher.

### SUMMARY OF THE INVENTION

The technical problem solved by the present invention is to provide a non-aqueous electrolyte for a lithium-ion battery which has better permeability and which is suitable for use in a battery system with higher compacted density, and further to provide a lithium-ion battery having higher electric capacity, better charge-discharge cycling performance and better high-temperature stability.

In order to address the above-said technical problem, a first technical solution adopted by the present invention is as follows:

A non-aqueous electrolyte for a lithium-ion battery, comprising:

an organic solvent;

a lithium salt; and

an additive, the additive including 1,2,3-trifluorobenzene in an amount of 0.1 wt % to 2 wt % based on the weight of the electrolyte.

In order to address the above-said technical problem, a second technical solution adopted by the present invention is as follows:

A lithium-ion battery, comprising a cathode, an anode, a separator membrane and a non-aqueous electrolyte, the non-aqueous electrolyte comprising an organic solvent, a lithium salt and an additive, the additive including 1,2,3-trifluorobenzene in an amount of 0.1 wt % to 2 wt % based on the weight of the electrolyte.

The beneficial effect of the present invention is as follows. In contrast to an electrolyte in the prior art, the electrolyte of the present invention is added with 1,2,3-trifluorobenzene in an amount of 0.1 wt % to 2 wt %. 1,2,3-trifluorobenzene contains three F atoms, which are a strong electron withdrawing group, and which are at adjacent positions with each other. This can increase the compatibility of the electrolyte with an electrode interface and greatly decrease the contact angle between the electrolyte and the highly compacted graphite anode. Thus, 1,2,3-trifluorobenzene plays a role like a surfactant, increasing the adhesion of the electrolyte to an electrode and hence markedly increasing the permeability of the electrolyte. The lithium-ion battery prepared using the electrolyte of the present invention shows a high capacity retention rate, an excellent cycling performance and an excellent high-temperature storage performance.

### DETAILED DESCRIPTION OF THE INVENTION

The present invention is described below with reference to embodiments in order to illustrate the technical content of the present invention as well as the objectives and the effects achieved.

The key concept of the present invention lies in the use of 1,2,3-trifluorobenzene as an additive for the electrolyte, which compared with a fluorobenzene compound in the prior art, can effectively increase the compatibility of the electrolyte with an electrode plate and enhance the permeability of the electrolyte into the electrode plate.

Specifically, the non-aqueous electrolyte for a lithium-ion battery provided by the present invention comprises:

an organic solvent;

a lithium salt; and

an additive, the additive including 1,2,3-trifluorobenzene in an amount of 0.1 wt % to 2 wt % based on the weight of the electrolyte.

The technical principle behind the present invention is as follows.

1,2,3-trifluorobenzene contains three F atoms, which are a strong electron withdrawing group, and which are at adjacent positions with each other. This can greatly decrease the contact angle between the electrolyte and the highly compacted graphite anode, and reduce the surface tension of the electrolyte on an electrode plate. Thus, 1,2,3-trifluorobenzene plays a role like a surfactant, increasing the adhesion of the electrolyte to an electrode and hence markedly increasing the permeability of the electrolyte. Moreover, 1,2,3-trifluorobenzene can form a film on the cathode, which can protect the cathode, thus improving the high-temperature storage performance and the cycling performance of the battery. Therefore, the electrolyte provided by the present invention shows better permeability and infiltrability in comparison to an electrolyte in the prior art, and is suitable for use in a battery system with higher compacted density, and the lithium-ion battery prepared therefore shows a high capacity retention rate, an excellent cycling performance and an excellent high-temperature storage performance.

With respect to the content of 1,2,3-trifluorobenzene in the electrolyte, when the content of 1,2,3-trifluorobenzene is lower than 0.1%, the improvement of the compatibility of the electrolyte with an electrode plate is limited, and the improvement of the permeability of the electrolyte is not duly achieved; while when the content of 1,2,3-trifluorobenzene is higher than 2%, oxygenolysis would readily occur on the cathode, resulting in increased cathode interface impedance and deteriorated battery performance.

Further, in the electrolyte for a lithium-ion battery, the electrolyte additive also includes one or a combination of more of vinylene carbonate, fluorinated ethylene carbonate and 1,3-propane sultone. As an additive, vinylene carbonate, fluorinated ethylene carbonate or 1,3-propane sultone is an excellent anode film-forming additive and can effectively enhance the cycling performance of the battery.

Further, in the electrolyte for a lithium-ion battery, the electrolyte additive also includes a dinitrile compound.

The dinitrile compound may complex with a metal ion, thus reducing decomposition of the electrolyte and inhibiting dissolution of the metal ion, which can protect the cathode and enhance the high-temperature performance of the battery.

Further, the dinitrile compound is selected from one or two or more of butanedinitrile (or succinonitrile), pentanedinitrile, hexanedinitrile, heptanedinitrile, octanedinitrile, nonanedinitrile and decanedinitrile.

Further, the non-aqueous organic solvent is selected from one or two or more of ethylene carbonate, propylene carbonate, butylene carbonate, dimethyl carbonate, diethyl carbonate, ethyl methyl carbonate and methyl propyl carbonate.

Further, the non-aqueous organic solvent is a composition of ethylene carbonate, diethyl carbonate and ethyl methyl carbonate.

Further, the lithium salt is selected from one or two or more of lithium hexafluorophosphate, lithium perchlorate, lithium tetrafluoroborate, lithium difluoro(oxalato)borate, lithium bis(trifluoromethanesulphonyl)imide and lithium bis(fluorosulfonyl)imide salts.

In particular, the lithium-ion battery provided by the present invention comprises a cathode, an anode, a separator membrane and a non-aqueous electrolyte, the non-aqueous electrolyte comprising an organic solvent, a lithium salt and an additive, the additive including 1,2,3-trifluorobenzene in an amount of 0.1 wt % to 2 wt % based on the weight of the electrolyte.

Further, the lithium-ion battery has a compacted density of the anode material of greater than or equal to 1.65 g/cm³.

Further, the additive also includes one or more of vinylene carbonate, fluorinated ethylene carbonate and 1,3-propane sultone.

Further, the additive also includes a dinitrile compound, the dinitrile compound being selected from one or two or more of butanedinitrile (or succinonitrile), pentanedinitrile, hexanedinitrile, heptanedinitrile, octanedinitrile, nonanedinitrile and decanedinitrile.

Further, the lithium salt is selected from one or two or more of lithium hexafluorophosphate, lithium perchlorate, lithium tetrafluoroborate, lithium difluoro(oxalato)borate, lithium bis(trifluoromethanesulphonyl)imide and lithium bis(fluorosulfonyl)imide salts.

Further, the lithium-ion battery has a charging cut-off voltage of greater than 4.2 V and smaller than or equal to 4.5 V.

### Example 1

In this example, the preparation method of the lithium-ion battery comprised a cathode preparation step, an anode preparation step, an electrolyte preparation step, a separator membrane preparation step and a battery assembling step.

The cathode preparation step comprised: mixing lithium cobalt oxide which acts as a high-voltage cathode active material, conductive carbon black, and polyvinylidenefluoride which acts as a binding agent in a mass ratio of 96.8:2.0:1.2, dispersing the mixture in N-methyl-2-pyrrolidone to obtain a cathode slurry, evenly coating the cathode slurry onto both sides of an aluminum foil, subjecting the coated aluminum foil to oven drying, calendering and vacuum drying, and welding an aluminum outgoing line with an ultrasonic welding machine to obtain a cathode plate, which had a thickness of between 120-150 μm. The compacted density of the cathode material was controlled by the areal density and the rolled thickness of the cathode material.

The anode preparation step comprised: mixing graphite, conductive carbon black, and styrene-butadiene rubber and carboxymethylcellulose which act as a binding agent in a mass ratio of 96:1:1.2:1.8, dispersing the mixture in deionized water to obtain an anode slurry, coating the anode slurry onto both sides of a copper foil, subjecting the coated copper foil to oven drying, calendering and vacuum drying, and welding an nickel outgoing line with an ultrasonic welding machine to obtain an anode plate, which had a thickness of between 120-150 μm. The compacted density of the anode material was controlled by the areal density and the rolled thickness of the anode material.

The electrolyte preparation step comprised: mixing ethylene carbonate (EC), diethyl carbonate (DEC) and ethyl methyl carbonate (EMC) in a volume ratio of 1:1:1, adding lithium hexafluorophosphate having a concentration of 1.0 mol/L, and then adding 1,2,3-trifluorobenzene as an additive in an amount of 0.1% based on the total weight of the electrolyte.

Testing of permeation time: in a dehumidified room and at a constant temperature, a small cathode plate and a small anode plate having the same dimension were respectively cut from the cathode plate and the anode plate prepared above, and were respectively accurately added dropwise with 2 μl of the electrolyte, and the time it took for the electrolyte to be completely absorbed into the electrode plates was recorded.

The separator membrane preparation step comprised: employing a three-layer separator membrane of polypropylene, polyethylene and polypropylene, the thickness being 20 μm.

The battery assembling step comprised: placing the three-layer separator membrane having a thickness of 20 μm between the cathode plate and the anode plate, winding the sandwich structure consisting of the cathode plate, the anode plate and the separator membrane, flattening the wound article and placing the article into a square aluminum metal casing, respectively welding the outgoing lines of the cathode and the anode to the corresponding positions on a cover plate, and welding the cover plate together with the metal casing with a laser welding machine to obtain a battery cell to be injected with the electrolyte prepared, and injecting the electrolyte via a liquid injection hole into the battery cell in an amount of the electrolyte such that any interspace in the battery cell was filled.

Subsequently, conventional battery formation at initial charging was conducted in the following steps: performing constant-current charging for 3 min at 0.05 C, performing constant-current charging for 5 min at 0.2 C, performing constant-current charging for 25 min at 0.5 C, standing for 1 hr, shaping and sealing, then further performing constant-current charging at 0.2 C to 4.35V, standing for 24 hr at ambient temperature, then performing constant-current discharging at 0.2 C to 3.0 V.

1) Testing of ambient-temperature cycling performance: at 25° C., performing constant-current and constant-voltage charging on the battery having been subjected to battery formation at 1 C to 4.35 V, and then performing constant-current discharging on the battery at 1 C to 3.0 V; and following 500 cycles of charging/discharging, calculating the capacity retention rate, the internal resistance increase rate and the thickness expansion rate at the 500^{th} cycle, the formulas for calculation being as follows:

Capacity retention rate at the 500^{th} cycle (%)=(discharge capacity at the 500^{th} cycle/discharge capacity at the 1^{st} cycle)×100%;

Thickness expansion rate at the 500^{th} cycle (%)=(thickness after the 500^{th} cycle−initial thickness before cycling)/initial thickness before cycling×100%;

Internal resistance increase rate at the 500^{th} cycle (%)=(internal resistance after the 500^{th} cycle−initial internal resistance before cycling)/initial internal resistance before cycling×100%.

2) Testing of high-temperature storage performance: performing constant-current and constant-voltage charging on the battery having been subjected to battery formation at ambient temperature at 1 C to 4.35 V, measuring the initial thickness and the initial discharge capacity of the battery, storing the battery at 60° C. for 30 days, measuring the final thickness of the battery when the battery cooled to ambient temperature, and calculating the battery thickness expansion rate; and then discharging the battery at 1 C to 3V, measuring the retention capacity and the recovery capacity, and calculating the battery capacity retention rate and the battery capacity recovery rate, the formulas for calculation being as follows:

Battery thickness expansion rate (%)=(final thickness−initial thickness)/initial thickness×100%;

Battery capacity retention rate (%)=retention capacity/initial capacity×100%;

Battery capacity recovery rate (%)=recovery capacity/initial capacity×100%.

### Example 2

Example 1 was repeated, except that as the additive, 1,2,3-trifluorobenzene was added in an amount of 0.5% in the electrolyte.

### Example 3

Example 1 was repeated, except that as the additive, 1,2,3-trifluorobenzene was added in an amount of 1% in the electrolyte.

### Example 4

Example 1 was repeated, except that as the additive, 1,2,3-trifluorobenzene was added in an amount of 2% in the electrolyte.

### Example 5

Example 1 was repeated, except that as the additive, 1,2,3-trifluorobenzene was added in an amount of 1%, fluorinated ethylene carbonate (FEC) was added in an amount of 3% and 1,3-propane sultone (PS) was added in an amount of 3% in the electrolyte.

### Example 6

Example 1 was repeated, except that as the additive, 1,2,3-trifluorobenzene was added in an amount of 1%, fluorinated ethylene carbonate (FEC) was added in an amount of 3%, 1,3-propane sultone (PS) was added in an amount of 3% and succinonitrile (SN) was added in an amount of 1% in the electrolyte.

### Example 7

Example 1 was repeated, except that as the additive, 1,2,3-trifluorobenzene was added in an amount of 1%, and the anode material prepared has a compacted density of 1.7 g/cm³.

### Example 8

Example 1 was repeated, except that as the additive, 1,2,3-trifluorobenzene was added in an amount of 1%, and the anode material prepared has a compacted density of 1.75 g/cm³.

### Comparative Example 1

Example 1 was repeated, except that the electrolyte was not added with any additive.

### Comparative Example 2

Example 1 was repeated, except that as the additive, 1,3,5-trifluorobenzene was added in an amount of 1% in the electrolyte.

### Comparative Example 3

Example 1 was repeated, except that as the additive, 1,2,4-trifluorobenzene was added in an amount of 1% in the electrolyte.

### Comparative Example 4

Example 1 was repeated, except that as the additive, fluorinated ethylene carbonate (FEC) was added in an amount of 3%, 1,3-propane sultone (PS) was added in an amount of 3% and succinonitrile (SN) was added in an amount of 1% in the electrolyte.

### Comparative Example 5

Example 1 was repeated, except that the electrolyte was not added with any additive, and the anode material prepared has a compacted density of 1.7 g/cm³.

### Comparative Example 6

Example 1 was repeated, except that the electrolyte was not added with any additive, and the anode material prepared has a compacted density of 1.75 g/cm³.

### Comparative Example 7

Example 1 was repeated, except that as the additive, fluorobenzene was added in an amount of 1% in the electrolyte.

### Comparative Example 8

Example 1 was repeated, except that as the additive, 1,3-difluorobenzene was added in an amount of 1% in the electrolyte.

### Comparative Example 9

Example 1 was repeated, except that as the additive, trifluorotoluene was added in an amount of 1% in the electrolyte.

### Comparative Example 10

Example 1 was repeated, except that as the additive, allyl pentafluorobenzene was added in an amount of 1% in the electrolyte.

Details of the above examples and comparative examples are shown in Table 1 below.

TABLE 1

| | Compacted | | |
|---|---|---|---|
| | density of | | |
| | anode | | |
| | material | 1,2,3- | |
| | (g/cm³) | trifluorobenzene | Other additives |
| Example 1 | 1.65 | 0.1% | |
| Example 2 | 1.65 | 0.5% | |
| Example 3 | 1.65 | 1% | |
| Example 4 | 1.65 | 2% | |
| Example 5 | 1.65 | 1% | FEC: 3%, PS: 3% |
| Example 6 | 1.65 | 1% | FEC: 3%, PS: 3%, |
| | | | SN: 1% |
| Example 7 | 1.7 | 1% | |
| Example 8 | 1.75 | 1% | |
| Comparative | 1.65 | | |
| example 1 | | | |
| Comparative | 1.65 | | 1,3,5-trifluorobenzene: |
| example 2 | | | 1% |
| Comparative | 1.65 | | 1,2,4-trifluorobenzene: |
| example 3 | | | 1% |
| Comparative | 1.65 | | FEC: 3%, PS: 3%, |
| example 4 | | | SN: 1% |
| Comparative | 1.7 | | |
| example 5 | | | |
| Comparative | 1.75 | | |
| example 6 | | | |
| Comparative | 1.65 | | fluorobenzene 1% |
| example 7 | | | |
| Comparative | 1.65 | | 1,3-difluorobenzene: |
| example 8 | | | 1% |
| Comparative | 1.65 | | trifluorotoluene: |
| example 9 | | | 1% |
| Comparative | 1.65 | | allyl |
| example 10 | | | pentafluorobenzene: |
| | | | 1% |

The data of permeation time detected for the above examples and comparative examples are shown in Table 2 below, and the data of ambient-temperature cycling and high-temperature storage detected for the above examples and comparative examples are shown in Table 3 below.

TABLE 2

| | Permeation time | Permeation |
|---|---|---|
| | for anode carbon | time for cathode |
| | material (s) | LiCoO₂ (s) |
| Example 1 | 510 | 600 |
| Example 2 | 338 | 590 |
| Example 3 | 314 | 585 |
| Example 4 | 310 | 580 |
| Example 5 | 315 | 586 |
| Example 6 | 320 | 588 |
| Example 7 | 330 | 586 |
| Example 8 | 350 | 586 |
| Comp. example 1 | 647 | 608 |
| Comp. example 2 | 620 | 602 |
| Comp. example 3 | 630 | 606 |
| Comp. example 4 | 635 | 605 |
| Comp. example 5 | 700 | 608 |
| Comp. example 6 | 843 | 608 |
| Comp. example 7 | 620 | 600 |
| Comp. example 8 | 610 | 602 |
| Comp. example 9 | 605 | 600 |
| Comp. example 10 | 600 | 605 |

It can be seen from the data in Table 2 that, in the case that no additive was added (Example 1, and Comparative examples 5-6), as the compacted density of the highly compacted cathode or anode increased, the permeation ability of the electrolyte gradually decreased; in the case that 1,3,5-trifluorobenzene (Comparative example 2), 1,2,4-trifluorobenzene (Comparative example 3) or a fluorobenzene compound other than 1,2,3-trifluorobenzene (Comparative examples 7-10) or an alternative additive (Comparative example 4) was added, no markedly change was seen in the permeation time of the electrolyte for the highly compacted cathode or anode, and the permeation time of the electrolyte for the graphite anode material having a compacted density of 1.65 g/cm³ only decreased from 647 s to 600 s, representing a mild increase in the permeation performance; in the case of adding 1,2,3-trifluorobenzene, the permeation time of the electrolyte for the highly compacted cathode or anode decreased to different degrees, with the decrease in the permeation time of the electrolyte for the anode material being more marked, and the permeation time of the electrolyte for the graphite anode material having a compacted density of 1.65 g/cm³ decreased from 647 s to 510 s or even down to 310 s, representing a significant increase in the permeation performance, and moreover, as the compacted density of the anode material increased, the effect of 1,2,3-trifluorobenzene on the improvement of the permeation performance of the electrolyte became more marked (when the compacted density was 1.7 g/cm³, the permeation time decreased from 700 s to 330 s, representing a nearly 1.06-fold increase in the permeation performance; and when the compacted density was 1.75 g/cm³, the permeation time decreased from 843 s to 350 s, representing a nearly 1.2-fold increase in the permeation performance).

Therefore, by adding 1,2,3-trifluorobenzene in the electrolyte, the present invention modifies the surface performance of the electrolyte, increase the adhesion of the electrolyte to the electrode plates, enhances the permeation performance of the electrolyte with respect to the electrode plates, particularly the anode. Thus, the present invention is especially suitable for a battery system having a compacted density of the anode of 1.65 g/cm³ or higher.

TABLE 3

| | Data of ambient-temperature cycling | | | | | |
|---|---|---|---|---|---|---|
| | (500 cycles) | | | Data of high-temperature storage | | |
| | | | Internal | (60° C., 30 days) | | |
| | Capacity | Thickness | resistance | Thickness | Capacity | Capacity |
| | retention | expansion | increase | expansion | retention | recovery |
| | rate (%) | rate (%) | rate (%) | rate (%) | rate (%) | rate (%) |
| Example 1 | 68 | 16.4 | 28.4 | 26.5 | 64.7 | 75.7 |
| Example 2 | 69.7 | 14.2 | 25.4 | 24 | 66.1 | 77.3 |
| Example 3 | 74.3 | 11.3 | 22 | 21.7 | 68.8 | 79.1 |
| Example 4 | 73.1 | 11.2 | 21 | 23.1 | 67.2 | 78 |
| Example 5 | 82.8 | 6.8 | 19.1 | 18.4 | 72 | 83.1 |
| Example 6 | 83.5 | 4.3 | 18.2 | 17.3 | 75.4 | 86 |
| Example 7 | 73.5 | 14.4 | 28.4 | 24 | 66.1 | 76.3 |
| Example 8 | 70.3 | 16.7 | 32.9 | 28.4 | 63.6 | 72.3 |
| Comp. | 63.1 | 20 | 34.5 | 30.7 | 62 | 74.3 |
| example 1 | | | | | | |
| Comp. | 62.4 | 23.4 | 37.4 | 35 | 59.1 | 70.2 |
| example 2 | | | | | | |
| Comp. | 63.3 | 21 | 34 | 31.7 | 61.5 | 72.8 |
| example 3 | | | | | | |
| Comp. | 76.2 | 8.8 | 20.4 | 20.1 | 71.4 | 83.5 |
| example 4 | | | | | | |
| Comp. | 60.5 | 25 | 40.6 | 35.7 | 57.1 | 70.3 |
| example 5 | | | | | | |
| Comp. | 55.1 | 34.7 | 46.7 | 41.3 | 52.9 | 65.2 |
| example 6 | | | | | | |
| Comp. | 55.5 | 21 | 33.8 | 20.8 | 60.4 | 68.1 |
| example 7 | | | | | | |
| Comp. | 50.1 | 22.3 | 35 | 21.9 | 53.5 | 70.3 |
| example 8 | | | | | | |
| Comp. | 51.8 | 25 | 29 | 22.5 | 55 | 75.1 |
| example 9 | | | | | | |
| Comp. | 57.6 | 20.8 | 31.7 | 21.3 | 60.1 | 73.9 |
| example 10 | | | | | | |

From the data in Table 3 it can be seen that in comparison to an electrolyte not comprising an infiltrating additive and in comparison to an electrolyte comprising 1,3,5-trifluorobenzene, 1,2,4-trifluorobenzene, another fluorobenzene compound or an alternative type of additive, the battery prepared using the electrolyte added with 1,2,3-trifluorobenzene showed markedly enhanced ambient-temperature cycling performance and high-temperature storage performance. The cathode material used in the Examples was lithium cobalt oxide. The same effect of improvement could be expected if a ternary material is used instead as the cathode material.

The above description only represents the examples of the present invention and is not intended to limit the patent scope of the present invention. Any equivalent modification made in light of the disclosure of the present invention, or any direct or indirect application of the present invention in relevant technical fields, is deemed to be encompassed within the scope of patent protection of the present invention.

What is claimed is:

1. A non-aqueous electrolyte for a lithium-ion battery, comprising an organic solvent, a lithium salt and an additive, wherein the additive includes 1,2,3-trifluorobenzene in an amount of 0.1 wt % to 2 wt % based on the weight of the non-aqueous electrolyte.

2. The non-aqueous electrolyte for a lithium-ion battery according to claim 1, wherein the additive also includes one or more of vinylene carbonate, fluorinated ethylene carbonate and 1,3-propane sultone.

3. The non-aqueous electrolyte for a lithium-ion battery according to claim 1, wherein the additive also includes a dinitrile compound, the dinitrile compound being selected from one or two or more of butanedinitrile, pentanedinitrile, hexanedinitrile, heptanedinitrile, octanedinitrile, nonanedinitrile and decanedinitrile.

4. The non-aqueous electrolyte for a lithium-ion battery according to claim 1, wherein the lithium salt is selected from one or two or more of lithium hexafluorophosphate, lithium perchlorate, lithium tetrafluoroborate, lithium difluoro(oxalato)borate, lithium bis(trifluoromethanesulphonyl)imide and lithium bis(fluorosulfonyl)imide salts.

5. A lithium-ion battery, comprising a cathode, an anode, a separator membrane and a non-aqueous electrolyte, wherein the non-aqueous electrolyte comprises an organic solvent, a lithium salt and an additive, the additive including 1,2,3-trifluorobenzene in an amount of 0.1 wt % to 2 wt % based on the weight of the non-aqueous electrolyte.

6. The lithium-ion battery according to claim 5, wherein the anode has a compacted density of greater than or equal to 1.65 g/cm³.

7. The lithium-ion battery according to claim 5, wherein the additive also includes one or more of vinylene carbonate, fluorinated ethylene carbonate and 1,3-propane sultone.

8. The lithium-ion battery according to claim 5, wherein the additive also includes a dinitrile compound, the dinitrile compound being selected from one or two or more of butanedinitrile, pentanedinitrile, hexanedinitrile, heptanedinitrile, octanedinitrile, nonanedinitrile and decanedinitrile.

9. The lithium-ion battery according to claim 5, wherein the lithium salt is selected from one or two or more of lithium hexafluorophosphate, lithium perchlorate, lithium tetrafluoroborate, lithium difluoro(oxalato)borate, lithium bis(trifluoromethanesulphonyl)imide and lithium bis(fluorosulfonyl)imide salts.

10. The lithium-ion battery according to claim 5, wherein the battery has a charging cut-off voltage of greater than 4.2 V and smaller than or equal to 4.5 V.
